(19) United States
(12) Patent Application Publication
(10) Pub. No.: US 2019/0036190 A1
(43) Pub. Date: Jan. 31, 2019

(54) TUNABLE WAVEGUIDE FILTERS

(71) Applicant: ZTE CORPORATION, Shenzhen (CN)

(72) Inventors: Zhiping FENG, Chapel Hill, NC (US); Edwin NEALIS, Cary, NC (US); Ying SHEN, Chapel Hill, NC (US)

(21) Appl. No.: 15/907,068

(22) Filed: Feb. 27, 2018

Related U.S. Application Data
(63) Continuation-in-part of application No. 15/659,376, filed on Jul. 25, 2017.

(51) Int. Cl. H01P 1/20; H01P 5/12; H01P 1/36

(52) U.S. Cl. CPC H01P 1/20; H01P 1/36; H01P 5/12

(57) ABSTRACT

A tunable radio frequency (RF) filter is provided. The tunable RF filter includes a first element and a second element that mates with the first element to form a waveguide. The waveguide includes a plurality of irises having band-pass characteristics. The tunable RF filter further includes a moveable dielectric plate disposed between the first element and the second element along a direction of propagation of the waveguide and a drive assembly that moves the moveable dielectric plate relative to the plurality of irises.

### RELATED APPLICATIONS

This application is a continuation-in-part of U.S. patent application Ser. No. 15/659,376, filed Jul. 25, 2017 and entitled “TUNABLE ANTENNA COUPLING UNIT (ACU) FOR MICROWAVE DIGITAL RADIOS”, which is hereby incorporated by reference in its entirety.

### TECHNICAL FIELD

This application relates generally to wireless telecommunication and particularly to tunable waveguide filters for microwave digital radios.

### BACKGROUND

Antenna coupling units (ACUs) are used to couple external circuitry (e.g., a modem or a transmitter/receiver (TRX) module) to an antenna. An ACU can perform a variety of functions. For example, ACUs often include transmission (Tx) and receiving (Rx) filters to limit the radio frequency (RF)/microwave signal to the required band and transmit/receive (T/R) spacing (e.g., as set by FCC regulations). In some circumstances, a regulation standard will provide multiple T/R spacings within a single frequency band. For example, the frequency band for each of receive and transmit channel may have a width of only one percent of the center frequency and the center frequencies may be separated by a frequency band of similar width. Conventional practice utilizes different hardware options for each Tx and Rx filter band. For example, in the 6/7/8 GHz bands, there are hundreds of ACU hardware options. The large amount of hardware options is a tremendous burden for today's communication equipment manufacturers, infrastructure vendors, and network providers.

### SUMMARY

An object of the present application is to provide flexibility, agility, and cost reduction for tuning a radio at a designated frequency band and T/R spacing. This decreases the equipment and manufacturing costs because the same hardware can be used to isolate different transmitter and receiver signals.

To that end, an antenna coupling unit is provided. The antenna coupling unit (ACU) includes a plurality of ports including a transmitter port, a receiver port, and an antenna port. The ACU further includes a circulator that isolates the transmitter port from the receiver port. A first waveguide couples the transmitter port with a first port of the circulator. The transmitter port receives an outgoing signal from first external circuitry. The first waveguide includes a first filter that filters the outgoing signal before routing the outgoing signal to the antenna port. A second waveguide couples a second port of the circulator with the receiver port. The second waveguide includes a second filter that filters an incoming signal received through the antenna port before routing the incoming signal to the receiver port. The receiver port provides the filtered incoming signal to second external circuitry. A third waveguide couples the antenna port with a third port of the circulator. At least one of the first filter and the second filter is a tunable filter.

In some embodiments, both the first filter and the second filter are tunable filters.

In some embodiments, the tunable filter is a tunable E-plane septum filter.

In some embodiments, the tunable E-plane septum filter includes a first element, a second element that mates with the first element to form a waveguide, an insert plate disposed between the first element and the second element along a direction of propagation of the waveguide, and a movable dielectric plate disposed parallel to the insert plate. A drive assembly varies a distance between the movable dielectric plate and the insert plate to vary a center frequency of the tunable E-plane septum filter.

In some embodiments, the movable dielectric plate comprises an alumina dielectric.

In some embodiments, the insert plate comprises a flat sheet (e.g., a flat metal sheet) having a plurality of resonant cavities comprising portions removed from the flat sheet (e.g., flat metal sheet).

In some embodiments, the ACU further includes a first isolator between the transmitter port and the first waveguide that isolates the transmitter port from signals traveling along the first waveguide toward the transmitter port and a second isolator between the receiver port and the second waveguide that isolates second waveguide from signals received through the receiver port from the first external circuitry.

In some embodiments, the plurality of ports, the circulator, the first waveguide, and the second waveguide are integrated into a single housing. In some embodiments, the housing includes a base having formed therein a first element of the first waveguide, a first element of the second waveguide and a first element of the third waveguide. The housing further includes a cover having formed therein a second element of the first waveguide, a second element of the second waveguide, and a second element of the third waveguide. The base and the cover mate to form the first waveguide, the second waveguide and the third waveguide.

In some embodiments, the first external circuitry and the second external circuitry are housed in a single external apparatus. In some embodiments, the first external circuitry and the second external circuitry are housed in separate external apparatus.

In some embodiments, an interior of the first waveguide and an interior of the second waveguide are plated with a metal.

Further, a tunable iris filter is provided. The tunable iris filter includes a first element and a second element that mates with the first element to form a waveguide. The waveguide includes a plurality of irises having band-pass characteristics. The tunable iris filter further includes a moveable dielectric plate disposed between the first element and the second element along a direction of propagation of the waveguide and a drive assembly that moves the moveable dielectric plate relative to the plurality of irises.

Further, a tunable septum filter is provided. The tunable RF septum filter includes a first element and a second element that mates with the first element to form a waveguide. The tunable RF septum filter further includes an insert plate disposed between the first element and the second element along a direction of propagation of the waveguide. The tunable RF septum filter further includes a movable dielectric plate disposed parallel to the insert plate and a drive assembly that varies a distance between the movable dielectric plate and the insert plate to vary a center frequency of the tunable E-plane septum filter.

### BRIEF DESCRIPTION OF DRAWINGS

The accompanying drawings, which are included to provide a further understanding of the embodiments and are incorporated herein and constitute a part of the specification, illustrate the described embodiments and together with the description serve to explain the underlying principles. Like reference numerals refer to corresponding parts.

FIG. 1 is a block diagram illustrating an antenna coupling unit, in accordance with some embodiments.

FIG. 2 is a perspective view of a base for an antenna coupling unit, in accordance with some embodiments.

FIG. 3 is an assembled view of an antenna coupling unit, in accordance with some embodiments.

FIG. 4 is an exploded view of an antenna coupling unit, in accordance with some embodiments.

FIG. 5 is a perspective view of an E-plane isolator with an H bend, in accordance with some embodiments.

FIG. 6A is a perspective view of an iris filter, in accordance with some embodiments.

FIG. 6B is a perspective view of a tunable iris filter, in accordance with some embodiments.

FIG. 7 is a perspective view of a tunable iris filter with a translatable dielectric plate, in accordance with some embodiments.

FIG. 8 is an exploded view of the tunable iris filter with a translatable dielectric plate, shown in FIG. 7, in accordance with some embodiments.

FIG. 9 is a perspective view of a tunable iris filter with a rotatable dielectric plate, in accordance with some embodiments.

FIGS. 10A-10B show various exploded views of the tunable iris filter with a rotatable dielectric plate, shown in FIG. 9, in accordance with some embodiments.

### DETAILED DESCRIPTION

Reference will now be made in detail to embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. With reference now to the figures, exemplary block diagrams of data processing environments are provided in which illustrative embodiments may be implemented. It should be appreciated that these figures are only exemplary and are not intended to assert or imply any limitation with regard to the environments in which different embodiments may be implemented. Many modifications to the depicted environments may be made.

As used herein, the term “couples with” implies that there may be other components besides the recited components in the coupling. For example, when a waveguide couples a first port with a second port, the waveguide is at least part of the coupling. The coupling may include other components as well that are not part of the first waveguide. As a more specific example, when a waveguide couples a first port with a second port, the coupling may include an isolator between the first port and the second port, where the isolator is not part of the waveguide. In this sense, the term “couples with” is different from “connects to,” which as used herein implies a direct connection. For example, the phrase “the first waveguide connects the first port to the second port,” as used herein, means that the only element between the first port and the second port is the first waveguide.

As used herein, the term “mechanical coupling” refers to a mechanical part that holds two or more other parts together, and is different from a waveguide or wave coupling device (e.g., which couple signals).

As used herein, the term “direction of propagation” (e.g., of a waveguide) means an axis of propagation, since electromagnetic waves can typically propagate forwards or backwards along a waveguide.

As used herein, a portion of a waveguide or wave coupling device is “formed” into a component (e.g., a larger component) when that portion of the waveguide is provided by the shape of the component (e.g., the portion of the waveguide is machined or otherwise shaped into the larger component).

As used herein, the term “portion” or “element” of a waveguide or wave coupling device refers to an incomplete waveguide or wave coupling device (e.g., half of a waveguide that forms a whole waveguide when mated with a complementary half). For example, in some circumstances, the top and bottom of a waveguide are constructed as separate portions (or elements) of the waveguide that form the whole waveguide when attached (mated). The term “section of a waveguide” refers to a complete waveguide, but not necessarily the entire length of the complete waveguide (e.g., if a waveguide is 3 inches long, the middle inch is a section of the waveguide).

The present disclosure provides ACUs with tunable filters on the transmitter and/or receiver sides. To do so, the present disclosure provides tunable E-plane septum filters based on the observation that, when a dielectric plate is positioned in an E-plane septum filter (e.g., a band-pass filter) parallel to the insert plate along the direction of the waveguide, the center frequency of the E-plane septum filter depends on the distance between the dielectric plate and the insert plate. Thus, the present disclosure provides a tunable E-plane septum filter that is tuned by varying the distance between a dielectric plate and an insert plate. These E-plane septum filters are used with ACUs to configure the ACUs to operate at different frequency bands and T/R spacings without swapping out hardware.

Further, the present disclosure provides tunable iris filters based on the observation that, when a dielectric plate is positioned in an iris filter (e.g., a band-pass filter) parallel to the direction of propagation of the waveguide, the center frequency of the iris filter can be varied by raising, lowering, or rotating the dielectric plate. These iris filters are used with ACUs to configure the ACUs to operate at different frequency bands and T/R spacings without swapping out hardware.

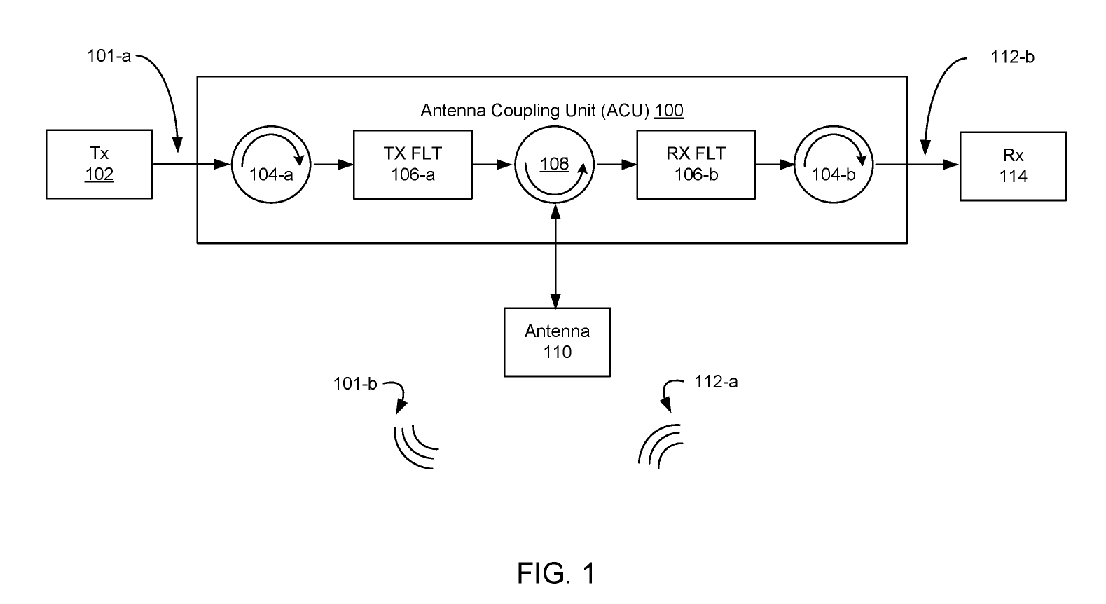

To that end, FIG. 1 is a block diagram illustrating an ACU 100, in accordance with some embodiments. ACU 100 receives an outgoing signal 101-a from a transmitter 102 (e.g., transmitter 102 comprises external circuitry such as a transmit portion of a modem or another external signal source) through a transmitter port (e.g., a first port of ACU 100). The outgoing signal 101-a is routed (e.g., passed) to an isolator 104-a, which prevents unwanted signals from travelling back toward transmitter 102 (e.g., isolator 104-a isolates the transmitter port from signals received through antenna 110). From isolator 104-a, the outgoing signal 101-a is filtered by transmitter filter 106-a (e.g., a band-pass filter that brings outgoing signal 101 into compliance with regulations). Filtered outgoing signal 101-b is then passed through a circulator 108 to antenna 110 and transmitted wirelessly.

Similarly, an incoming signal 112-a is received wirelessly through antenna 110. Incoming signal 112-a is passed through circulator 108 to receiver filter 106-b. Receiver filter 106-b filters the incoming signal according to its permitted band, thus removing unwanted noise outside of the receive channel's band. Filtered signal 112-b is then passed through isolator 104-b to second external circuitry (e.g., a receiver 114).

In some embodiments, transmitter 102 and receiver 114 are housed in the same external apparatus (e.g., a transmitter/receiver (TRX) module, coupled with ACU 100). In some embodiments, transmitter 102 and receiver 114 are housed in separate external apparatus.

Circulator 108 passes signals coming from the transmitter side to antenna 110 and signals received from antenna 110 to the receiver side. In some embodiments, circulator 108 is a three-port circulator. In some embodiments, isolator 104-b assures that no signals are traveling from the receiver side toward the circulator (e.g., which would otherwise be passed to the transmitter side via the rotation of circulator 108).

In some embodiments, at least one of transmitter filter 106-a and receiver filter 106-b is a tunable filter (e.g., any of the tunable filters described herein, such as the tunable septum filters or tunable iris filters described herein). The tunable nature of transmitter filter 106-a and/or receiver filter 106-b allows ACU 100 to be used for a plurality of frequency bands and T/R spacing options (e.g., rather than having fixed filters limited to one T/R spacing within one frequency band). In some embodiments, both transmitter filter 106-a and receiver filter 106-b are tunable filters. In some embodiments, the tunable filters described herein are band-pass filters that are tuned to modify a center frequency of a band that is passed by the tunable filter (e.g., the tuning modifies the center frequency). In some embodiments, tuning the tunable band-pass filters leaves the width of the passed band unchanged (e.g., 1% of the center frequency). Thus, the tunable filters described herein allow the ACU 100 to be adapted for different T/R spacings without changing the hardware (e.g., by tuning the tunable filters instead of using different filters for different T/R spacings).

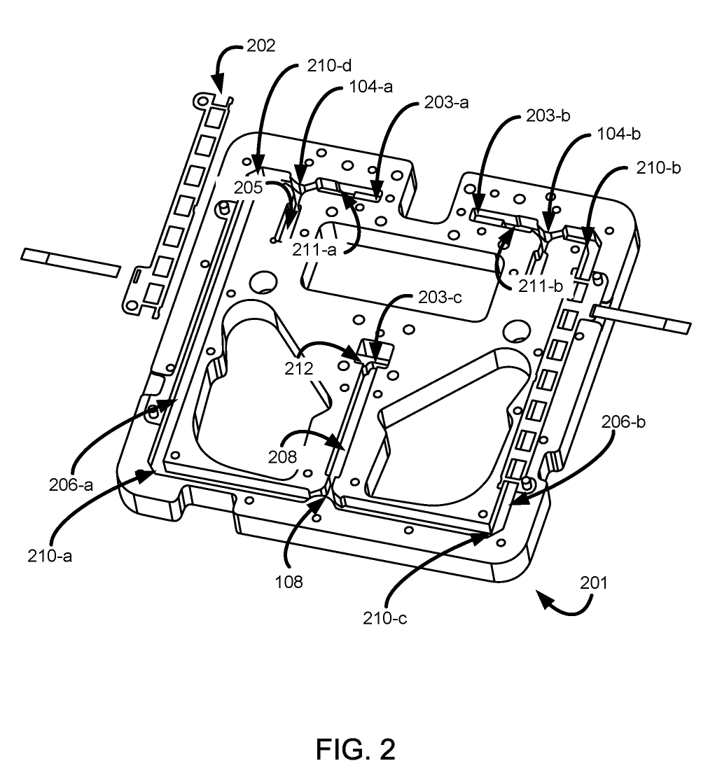

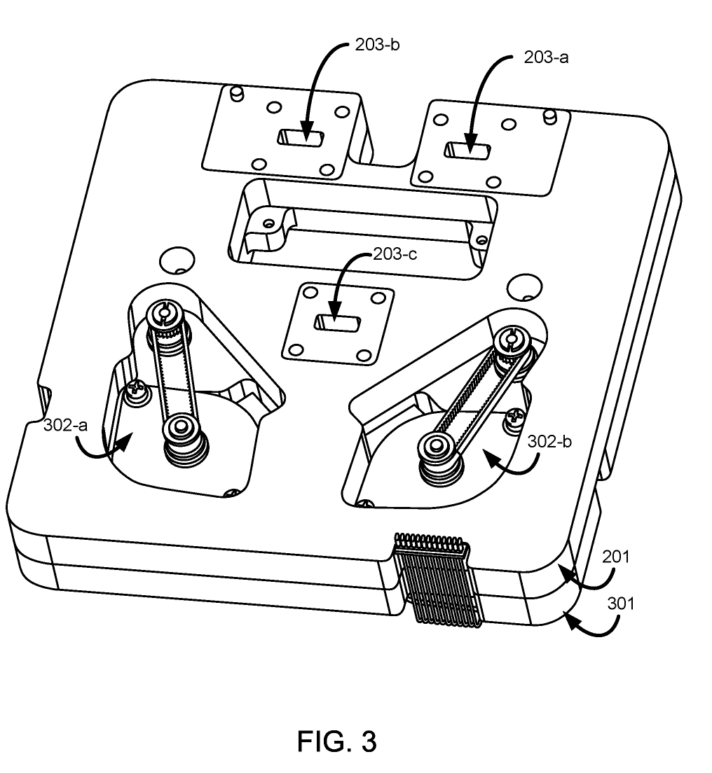

FIG. 2 is a perspective view of a base 201 that forms a portion of ACU 100 (FIG. 1), in accordance with some embodiments. FIG. 3 is an assembled view of ACU 100, in accordance with some embodiments. FIGS. 2-3 are described together below.

Base 201 includes a plurality of ports 203 of ACU 100. The ports 203 include a transmitter port 203-a, and receiver port 203-b, and an antenna port 203-c (e.g., with which antenna 110 is mechanically coupled). The ACU 100 is mechanically coupled to one or more external apparatuses through transmitter port 203-a and receiver port 203-b. For example, in some embodiments, ACU 100 is coupled to transmitter/receiver (TRX) module via transmitter port 203-a and receiver port 203-b. The transmitter port 203-a receives an outgoing signal from the first external circuitry (e.g., a transmitter in the TRX module). The receiver port 203-b provides a filtered incoming signal to the second external circuitry (e.g., a receiver in the TRX module). In some embodiments, the TRX module is housed within a single housing.

When mated with a cover 301 (FIG. 3), base 201 forms several waveguides and wave coupling devices (e.g., circulators and isolators). In particular, base 201 includes:
a portion of circulator 108 that isolates transmitter port 203-a from receiver port 203-b;
respective portions of isolators 104, where each isolator 104 isolates a respective port from signals traveling in the opposite direction (e.g., where the “opposite” direction is defined by the nature of the port, with signals travelling from the transmitter port 203-a and to the receiver port 203-b);
a portion of first waveguide 206-a that couples transmitter port 203-a with a first port of circulator 108. First waveguide 206-a includes first filter 106-a (FIG. 1) that filters the outgoing signal before routing the outgoing signal to antenna port 203-c;
a portion of second waveguide 206-b that couples a second port of circulator 108 with the receiver port 203-b. Second waveguide 206-b includes second filter 106-b (FIG. 1) that filters an incoming signal received through the antenna port 203-c before routing the incoming signal to the receiver port 203-b. The receiver port 203-b provides the filtered incoming signal to second external circuitry;
a portion of third waveguide 208 that couples antenna port 203-c with a third port of circulator 108;
respective portions of a plurality of waveguide E bends 210 (e.g., waveguide E bends 210-a through 210-d);
respective portions of a plurality of waveguide H bends 211 (e.g., waveguide H bends 211-a and 211-b); and
a portion of waveguide twist 212.

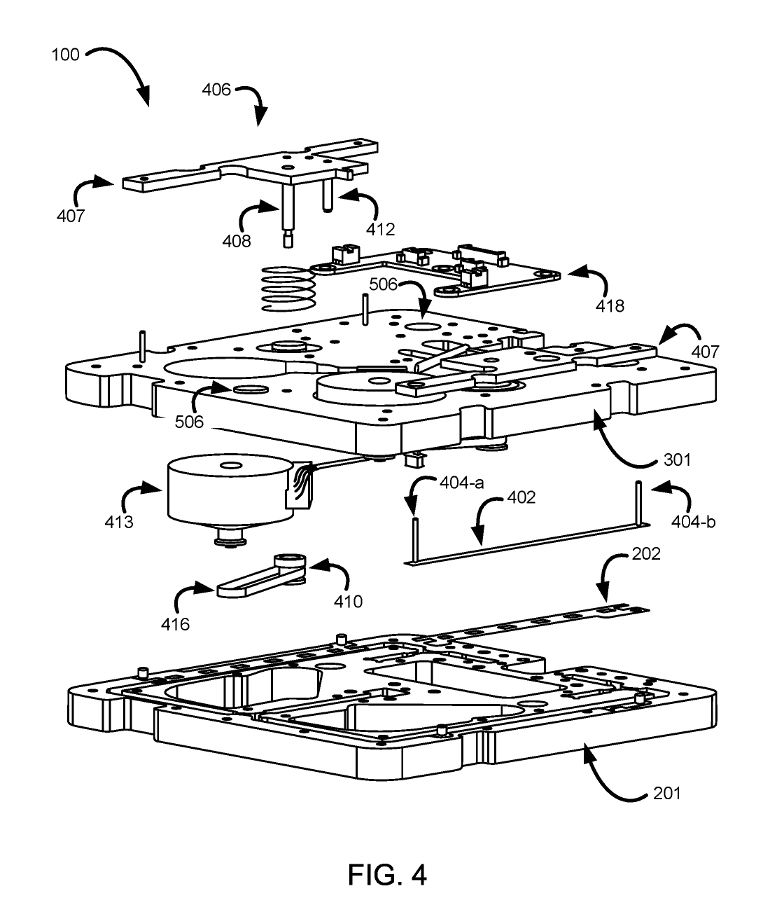

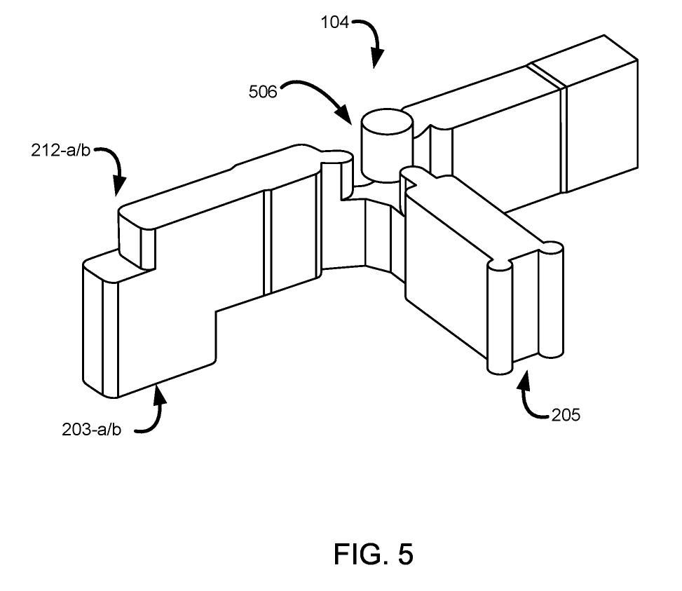

In some embodiments, cover 301 (FIGS. 3 and 4) includes complementary portions of these components (e.g., waveguides and wave coupling devices). For example, other (e.g., complementary) portions of these components are formed in cover 301, so that when base 201 is mechanically mated to cover 301, the waveguides and wave coupling devices described above are formed. Of course, these waveguides and wave coupling devices can include additional elements that are not formed in base 201 or cover 301 (e.g., elements that are inserted between base 201 and cover 301). For example, in some embodiments, each waveguide 206 includes an insert plate 202 and a movable dielectric plate 402 (FIG. 4) that is part of a filter 106 (FIG. 1). In some embodiments, each isolator 104 and circulator 108 includes a ferrite disk sandwiched between base 201 and cover 301. In some embodiments, each isolator 104 and circulator 108 includes magnet disk 506 that is placed on the front side of the housing over the ferrite disk. One port (e.g., of three ports) of each isolator is terminated (FIG. 5).

In some embodiments, the plurality of ports 203 (e.g., transmitter port 203-a, receiver port 203-b, and antenna port 203-c), first waveguide 206-a, and second waveguide 206-b are integrated into a single housing formed by the union of base 201 and cover 301. In some embodiments, third waveguide 208 is also integrated into the single housing.

Waveguide E bends 210 modify the direction of propagation of the waveguide (e.g., by 90 degrees with respect to the E-plane). Thus, waveguide E bends 210 are used in some embodiments to maintain a compact shape and size of ACU 100. Waveguide H bends 211 modify the direction of propagation of the waveguide (e.g., by 90 degrees with respect to the H-plane). In some embodiments, waveguide H bends 211 are coupled to or include portions that operate as ports 203, connecting the signals perpendicularly incident to ACU 100. Thus, waveguide H bends 211 are used in some embodiments to modify a signal arriving as a wave perpendicularly incident to ACU 100. Waveguide twist 212 is used, in some embodiments, to twist and bend the waveguide. In some embodiments, waveguide twist 212 is coupled to or includes a portion that operates as antenna port 203-c.

In some embodiments, first isolator 104-a and second isolator 104-b comprise three-port circulators where one of the ports is terminated (e.g., first isolator 104-a is terminated with terminator 205) (FIG. 5). In such embodiments, the rotation of the circulator isolates one of the remaining ports from the other. For example, when circulator 108 passes a signal from a first port to a second port, a second port to a third port, and a third port to the first port, terminating the second port isolates the third port from the first port, so that signals can pass from the third port to the first port but not from the first port to the third port.

In some embodiments, transmitter filter 106-a (FIG. 1) comprises a section of waveguide 206-a, insert plate 202, and a movable dielectric plate 402 (FIG. 4). The outgoing signal is routed to circulator 108 before reaching antenna 110 (e.g., through antenna port 203-c). In some embodiments, transmitter filter 106-a couples transmitter port 203-a with a first port of circulator 108, which passes the outgoing signal from the first port to a second port of the circulator 108.

In some embodiments, receiver filter 106-b (FIG. 1) couples receiver port 203-b (FIG. 2) with a third port of circulator 108. Receiver filter 106-b (FIG. 1) is coupled with isolator 104-b to filter an incoming signal received from antenna 110 (e.g., through antenna port 203-c) and provides the filtered incoming signal 112-b to second external circuitry 114. In some embodiments, isolator 104-b is between the receiver port 203-b and the second waveguide 206-b to isolate the second waveguide 206-b from signals received through the receiver port 203-b from the second external circuitry (e.g., isolate the second waveguide 206-b from noise signals going the opposite direction).

A third waveguide 208 is coupled to a second port of circulator 108. A first element of third waveguide 208 is formed in base 201 (e.g., the first element makes up half of the third waveguide). The third waveguide 208 carries transmission signals from circulator 108 to antenna 110 and received signals from antenna 110 to circulator 108.

In some embodiments, circulator 108 operates as follows: signals received at the first port of the circulator are passed to the second port of the circulator; signals received at the second port of the circulator are passed to the third port of the circulator; signals received at the third port of the circulator are passed to the first port of the circulator (but because the third port of the circulator is coupled with and isolated from the receiver port 203-b of the ACU, signals are not typically incident on the third port of the circulator, so that nothing is passed from the receive side of the ACU to the transmit side of the ACU). Signals are not passed in the opposite directions: signals received at the second port of the circulator are not passed to the first port of the circulator; signals received at the third port of the circulator are not passed to the second port of the circulator; signals received at the first port of the circulator are not passed to the third port of the circulator. Thus, circulator 108 is a non-reciprocal device. The operation described above is referred to as circulator 108's “rotation.”

As noted above, at least one of transmitter filter 106-a and receiver filter 106-b is a tunable filter. In some embodiments, transmitter filter 106-a and receiver filter 106-b are both tunable filters. In some embodiments, the one or more tunable filters are tunable E-plane septum filters or tunable iris filters. In some embodiments, the one or more tunable E-plane septum filters or tunable iris filters are each integrated into a waveguide that comprises a first element formed in cover 301 (FIG. 3) and a second element formed in base 201. Base 201 and cover 301 mate to form the waveguide (e.g., either waveguide 206) from the first element and the second element (e.g., each of the first element and the second element is half of the waveguide). In some embodiments, the formed waveguide is a linear waveguide segment. In some embodiments, the first element and the second element of the waveguide are made of a conductive material (e.g., base 201 and/or cover 301 are metal pieces). In some embodiments, an interior of the waveguide is plated with a different metal (e.g., silver). For example, in some embodiments, base 201 and/or cover 301 are plated with silver, which has been found to reduce the insertion loss of the waveguide. In some embodiments, when mated, the waveguide is a hollow tube with a rectangular cross-section perpendicular to a direction of propagation. Other components (e.g., filter components) may be disposed within the waveguide.

The E-plane septum filter described above further includes an insert plate 202 (e.g., a septum insert, FIG. 2) disposed between (e.g., sandwiched between) the first element (e.g., formed in base 201) and second element (e.g., formed in cover 301, FIG. 3) of the waveguide. The insert plate 202 is disposed lengthwise along the direction of propagation of the waveguide. In some embodiments, the insert plate 202 comprises a flat sheet (e.g., a flat metal sheet) having a plurality of dielectric resonant cavities. In some embodiments, the dielectric resonant cavities are portions removed from the flat sheet (e.g., the flat metal sheet) (e.g., the dielectric is air). The E-plane septum filter also includes a movable dielectric plate 402 (as described with reference to FIG. 4). When both transmitter filter 106-a and receiver filter 106-b are tunable E-plane septum filters, each of transmitter filter 106-a and receiver filter 106-b has an insert plate and a movable dielectric plate.

The E-plane septum filters described above are tunable by mechanically adjusting the position of the movable dielectric plate (shown in FIG. 4) that lies parallel to insert plate 202. In some embodiments, the position of the dielectric plate for each filter is controlled using a motor and drive assembly system 302 (FIG. 3). The operation of motor and drive assembly 302 is described in greater detail with reference to FIG. 4.

FIG. 4 is an exploded view of antenna coupling unit 100, in accordance with some embodiments. As described previously, ACU 100 includes base 201 and cover 301. When mated, base 201 and cover 301 form first waveguide 206-a, second waveguide 206-b, and third waveguide 208 (FIGS. 2 and 3). First waveguide 206-a includes first filter 106-a (e.g., a transmitter filter) and second waveguide 206-b includes second filter 106-b (e.g., a receiver filter), as shown in FIGS. 1 and 2. At least one (and in some embodiments, both) of first filter 106-a and second filter 106-b is a tunable filter (e.g., tunable E-plane septum filters or a tunable iris filter).

In accordance with some embodiments, a tunable filter 106 (e.g., an E-plane septum filter) comprises a section of a waveguide (e.g., a waveguide 206), an insert plate 202 having a plurality of dielectric resonant cavities disposed lengthwise along a direction of propagation of the waveguide, and a movable dielectric plate 402 disposed parallel or substantially parallel to the insert plate 202 (e.g., also along the direction of propagation of the waveguide). In some embodiments, movable dielectric plate 402 comprises (e.g., is made of) an alumina dielectric. In some embodiments, the entirety of movable dielectric plate 402 is made of a dielectric (e.g., there are no conductive sections within movable dielectric plate 402).

The one or more tunable filters 106 are each tuned by a motor and drive assembly 302 (FIG. 3) that varies (e.g., adjusts) a distance between movable dielectric plate 402 and insert plate 202 to modify one or more characteristics of the filter 106 (e.g., a center frequency of the tunable E-plane septum filter). To that end, motor and drive assembly 302 (FIG. 3) includes a lifter plate assembly 406 (FIG. 4). Lifter plate assembly 406 includes plate 407 and shaft 408 that has a threaded end. Shaft 408 is securely fastened to plate 407 (e.g., fit and glued in a hole in plate 407) so that shaft 408 cannot rotate relative to plate 407. The end of shaft 408 is threaded on its exterior and engages with a threaded pulley 410 (which has an interior threaded bore through which the end of shaft 408 is threaded). Thus, when threaded pulley 410 turns, shaft 408 screws further in or out depending on the direction of rotation of threaded pulley 410.

Movable dielectric plate 402 includes a plurality of rods 404 (e.g., dielectric rods such as alumina rods). Rods 404 pass through holes in cover 301 and are securely fastened in a threadless hole of plate 407 (e.g., glued to the hole of plate 407), so that when shaft 408 and plate 407 go up or down, rods 404 go up and down with them (moving dielectric plate 402 up and down as well). Lifter plate assembly 406 also includes pin 412 (e.g., a threadless pin). Pin 412 fits loosely in a hole of cover 301 so that pin 412 can move up and down freely within cover 301. At the same time, pin 412 prevents movable dielectric plate 402 from rotating. A motor 413 engages (e.g., turns) threaded pulley 410 via a belt 416 wrapped around the outside of threaded pulley 410.

A motor 413 is controlled by a controller board 418 and optionally one or more external control signals received through the controller board 418. Calibration of the tuning parameters is performed at one or more temperatures (e.g., room temperature) and the calibration data is optionally stored on controller board 418 (e.g., in EEPROM memory). For example, in some embodiments, calibration is performed at room temperature to obtain a first set of tuning parameters, allowing the transmitter and receiver filters 106 to be tuned at room temperature. In some embodiments, calibration is performed at a second temperature (e.g., above or below room temperature) to obtain a second set of tuning parameters. Thus, in some embodiments, the external control signal requests a particular center frequency for the tunable filter 106 and the controller board 418 actuates motor 413 to achieve the desired center frequency using the calibration data stored on controller board 418, which can be done for different temperatures and/or by extrapolating between temperatures.

FIG. 5 is a perspective view of an E-plane isolator 104 with an H bend, in accordance with some embodiments. In some embodiments, E-plane isolator 104 includes magnet disk 506.

To facilitate use of E-plane isolator 104, H-plane port 203-a/c is coupled with E-plane isolator 104 by an H bend 211. Isolator 104 comprises a circulator having one port terminated by a terminator 205. A circulator is a non-reciprocal three- or four-port microwave device, in which a microwave or radio frequency signal entering any port is transmitted, in the ideal case, only to the next port in a rotation direction. This is called “non-reciprocal behavior” because the transmission between a first port and a second port is not the same as the transmission between the second port and the first port. A port in this context is a point where a waveguide connects to the circulator. For a three-port circulator, a signal applied to port S1 only comes out of port S2; a signal applied to port S2 only comes out of port S3; and a signal applied to port S3 only comes out of port S1. The circulator includes a magnet 506 (FIG. 5) and ferrite disk (not shown).

Waveguide twist 212 rotates the H-plane and the E-plane of waveguide 208 by 90 degrees and bends the waveguide in the E-plane. Thus, waveguide twist 212 is used, in some embodiments, to transform a signal arriving as an RF/microwave wave perpendicularly incident to the ACU 100 (e.g., through antenna 110) so that the signal can be processed using E-plane components within the plane of the ACU 100. Conversely, in some embodiments, waveguide twist 212 is also used to transform RF/microwave waves that have undergone processing within ACU 100 to be transmitted through antenna 110.

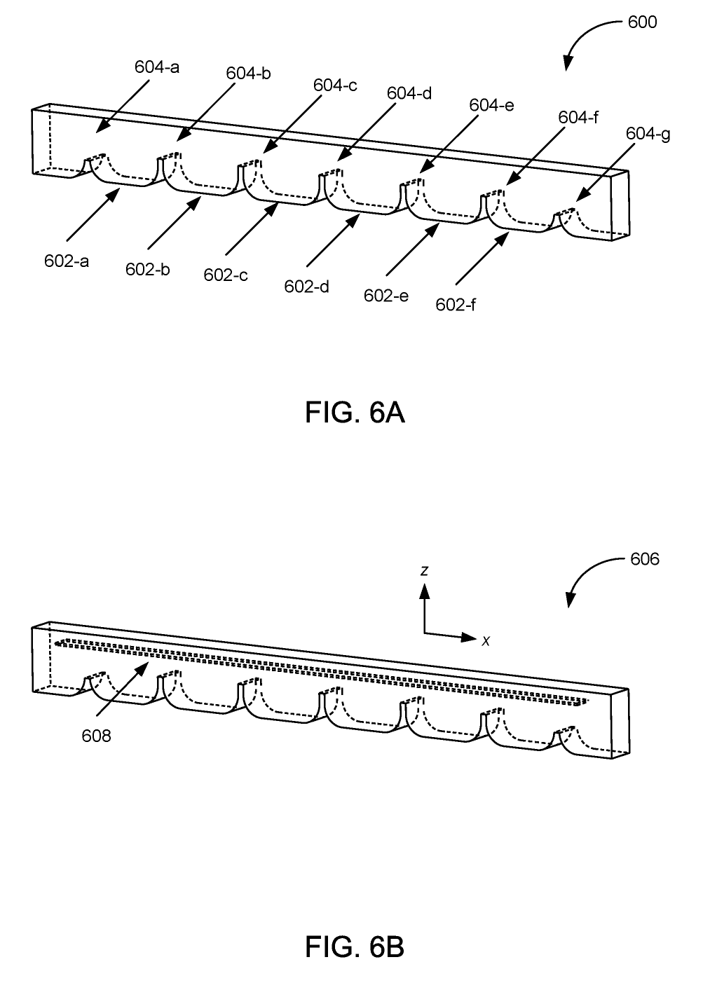

FIG. 6A is a perspective view of an iris filter 600, in accordance with some embodiments. Iris filter 600 is a band-pass filter (e.g., can be used in a transmitter of an antenna coupling unit to assure that the transmitted signal remains within the frequency band required by regular).

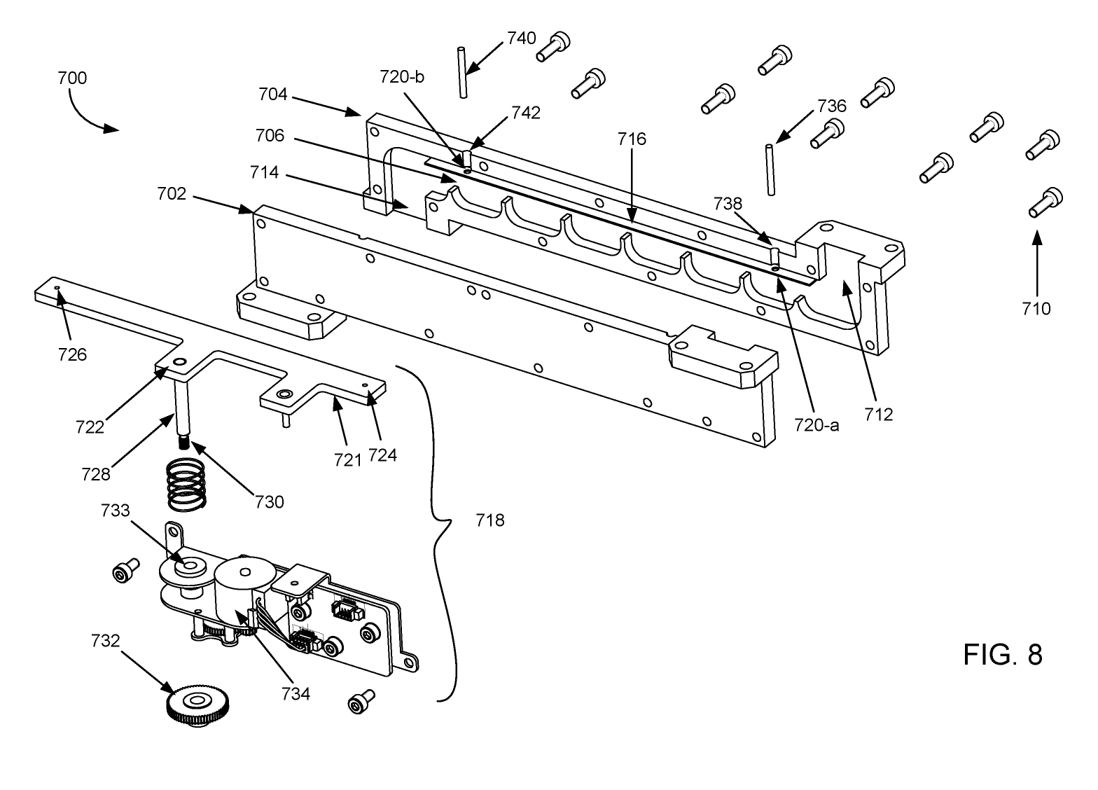

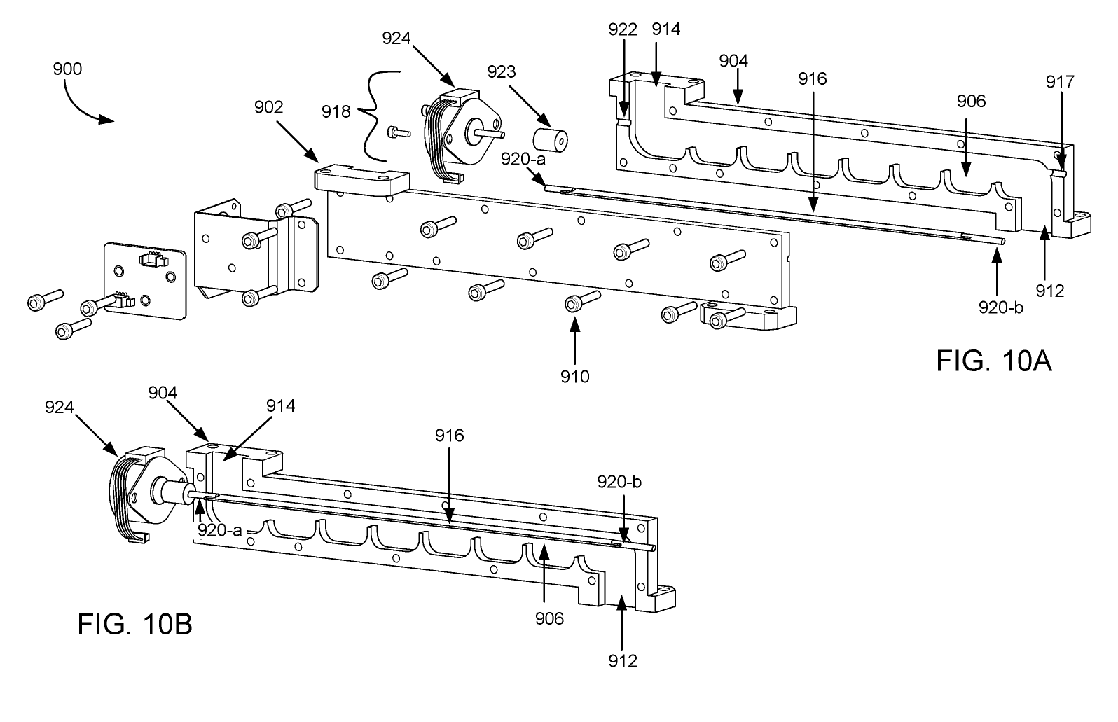

FIG. 6A illustrates a cavity (e.g., a negative space) formed by a first element (e.g., a machined metal component) mated with a second element (e.g., another machined metal component) wherein the mating creates the negative space. (In FIGS. 6A-6B, the first element and the second element are not shown, but they similar to those shown, for example, in FIGS. 8 and 10). Iris filter 600 includes a plurality of resonant regions 602 (e.g., 602-a through 602-f). The resonant cavities are separated by a plurality of irises 604 (e.g., iris 604-a through 604-g).

FIG. 6B is a perspective view of a tunable iris filter 606, in accordance with some embodiments. The tunable iris filter 606 shown in FIG. 6B is analogous to the iris filter shown 600 shown in FIG. 6A with the exception that tunable iris filter 606 includes a moveable dielectric plate 608 disposed between the first element and the second element along a direction of propagation of the waveguide. As described below, in some embodiments, the movable dielectric plate 608 is translatable (e.g., up-and-down, along a direction z perpendicular to an axis of propagation x of the waveguide rather than along the axis of propagation of the waveguide). In some embodiments, the moveable dielectric plate 608 is rotatable. In some embodiments, the moveable dielectric plate 608 passes over one or more of the plurality of irises. In some embodiments, the moveable dielectric plate 608 moves relative to a top of the waveguide. In some embodiments, the movable dielectric plate comprises an alumina dielectric. In some embodiments, iris filter 606 can be used as tunable filter 106-a and/or tunable filter 106-b, FIG. 1.

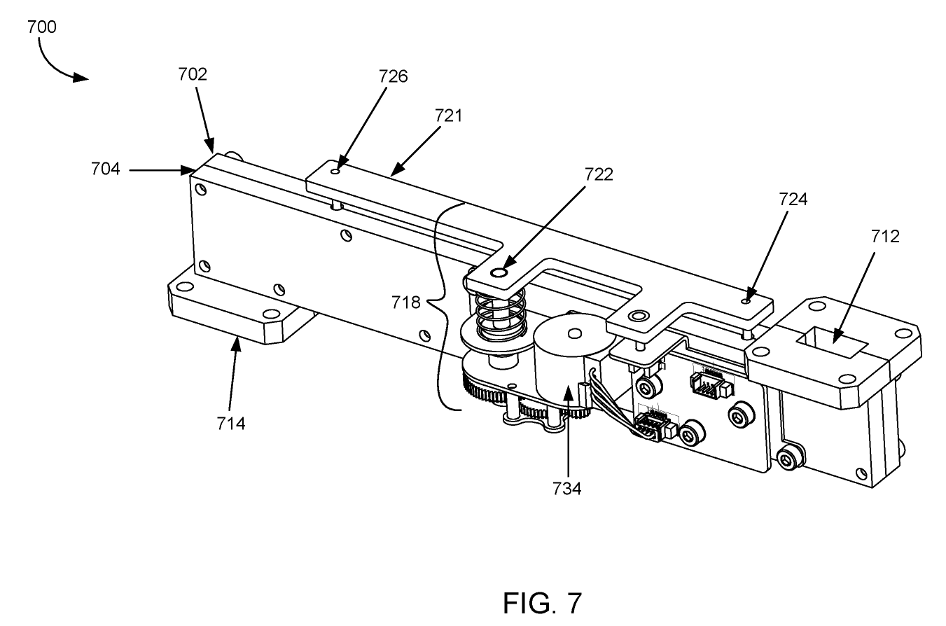

FIG. 7 is a perspective view of a tunable iris filter 700 with a translatable dielectric plate, in accordance with some embodiments. FIG. 8 is an exploded view of the tunable iris filter 700 with a translatable dielectric plate, shown in FIG. 7, in accordance with some embodiments. FIGS. 7-8 should be viewed together. In some embodiments, iris filter 700 can be used as tunable filter 106-a and/or tunable filter 106-b, FIG. 1.

Tunable iris filter 700 comprises a first element 702 (e.g., a machined metal component) and a second element 704 (e.g., a machined metal component distinct and separate from the first element). When mated, the first element 702 and the second element 704 form a waveguide 706 (e.g., the first element 702 and the second element 704 are bolted together using a plurality of bolts 710).

Tunable iris filter 700 further comprises a moveable dielectric plate 716 disposed between the first element 702 and the second element 704. The movable plate 716 optionally includes any of the characteristics described above with reference to movable plate 608, FIG. 6B. Moveable dielectric plate 716 (e.g., an alumina plate) is disposed along a direction of propagation of the waveguide 706 (e.g., within the waveguide 706). In some embodiment, moveable dielectric plate 716 passes over one or more of the plurality of irises (e.g., passes over two or more of the plurality of irises). In some embodiments, the moveable dielectric plate passes over each of the plurality of irises.

Tunable iris filter 700 includes an input port 712 and an exit port 714. In some embodiments, the waveguide 706 is bent (e.g., with a waveguide bend) upon entering the input port 712 (e.g., so that the direction of propagation of the input port 712 is perpendicular to the direction of propagation along a portion of the waveguide 706 that includes the irises). In some embodiments, the waveguide 706 is bent (e.g., with a waveguide bend) before exiting the exit port 714 (e.g., so that the direction of propagation of the exit port 714 is perpendicular to the direction of propagation along a portion of the waveguide 706 that includes the irises).

Tunable iris filter 700 includes a drive assembly 718 for translating the movable dielectric plate 716. To that end, the moveable dielectric plate 716 includes hole 720-a (and, optionally hole 720-b) that couple to the drive assembly 718. The drive assembly 718 includes several components that are external to the waveguide 706. In particular, the drive assembly 718 includes, external to the waveguide 706: a lifter plate 721 having a first hole 722 and a second hole 724 (and an optional third hole 726 analogous to second hole 724); a shaft 728 coupled with the lifter plate 721 through the first hole 722 in the lifter plate 721 (the shaft having a threaded end 730 distal to the first hole 722 in the lifter plate 721); a mechanical coupling 732 (e.g., a gear) having a threaded bore that mates with the threaded end 730 of the shaft 728; and a stepper motor 734 that turns the mechanical coupling 732 (e.g., via a transmission including one or more gears). The drive assembly 718 further includes a rod 736, passing through a hole 738 in the waveguide 706 (and optionally, a rod 740 passing through a hole 742 in the waveguide). The rod 736 is coupled with the lifter plate 721 through the second hole 724 in the lifter plate 721 and coupled with the moveable dielectric plate 716 through the hole 720-a in the moveable dielectric plate 716. The optional rod 740 is coupled with the lifter plate 721 through the optional third hole 726 in the lifter plate 721 and coupled with the moveable dielectric plate 716 through the optional hole 720-b in the moveable dielectric plate 716.

The holes 738 and 742 in the waveguide provide enough clearance for rods 736 and 740, respectively, to allow rods 736 and 740 to move up and down within holes 738 and 742 (e.g., smoothly). Hole 724 is designed so that rod 736 is securely fastened within hole 724 (e.g., sized so that rod 736 is fit and glued within hole 724). Hole 726 is designed so that rod 740 is securely fastened within hole 726 (e.g., sized so that rod 740 is fit and glued within hole 726). Thus, movement of lifter plate 721 moves rods 736 and 740.

Holes 720-a and 720-b in moveable dielectric plate 716 are also configured so that rods 736 and 740 are, respectively, securely fastened within holes 720-a and 720-b (e.g., holes 720-a and 720-b are sized such that rods 736 and 740 are fit within holes 720-a and 720-b). Thus, movement of lifter plate 721 moves with rods 736 and 740 and, in turn, lifts or lowers movable dielectric plate 716.

Similarly, shaft 728 is securely fastened within hole 722. Stepper motor 734 turns the mechanical coupling 732, which lifts or lowers shaft 728 but turning the threaded end of 730 in or out of the mechanical coupling 732. Shaft 728 is supported by and moves smoothly within (up and down relative to) bearing 733. Thus, drive assembly 718 provides a way to raise or lower movable dielectric plate 716 (within waveguide 706) with components such as a stepper motor that are external to the waveguide 706. The position of the movable dielectric plate 716 within waveguide 706 changes the center frequency of the band-pass filter 700 (e.g., without substantially modifying the bandwidth of the band-pass filter 700).

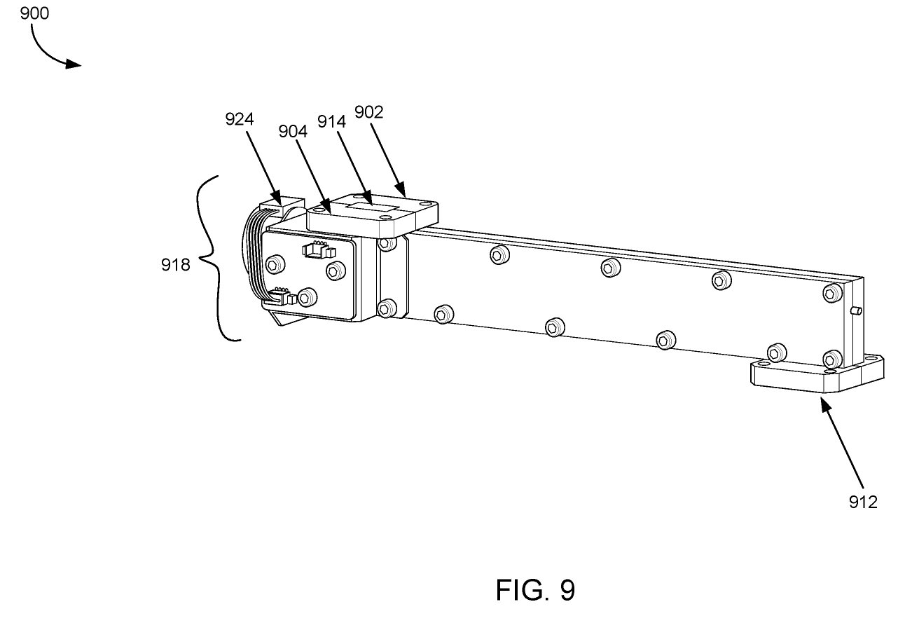

FIG. 9 is a perspective view of a tunable iris filter 900 with a movable (e.g., rotatable) dielectric plate 916, in accordance with some embodiments. FIGS. 10A-10B show various exploded views of the tunable iris filter with a rotatable dielectric plate, shown in FIG. 9, in accordance with some embodiments. FIGS. 9 and 10A-10B should be viewed together. In some embodiments, iris filter 900 can be used as tunable filter 106-a and/or tunable filter 106-b, FIG. 1.

Tunable iris filter 900 comprises a first element 902 (e.g., a machined metal component) and a second element 904 (e.g., a machined metal component distinct and separate from the first element). When mated, the first element 902 and the second element 904 form a waveguide 906 (e.g., the first element 902 and the second element 904 are bolted together using a plurality of bolts 910).

Tunable iris filter 900 further comprises a moveable dielectric plate 916 disposed between the first element 902 and the second element 904 (e.g., within the waveguide 906). The movable plate 916 optionally includes any of the characteristics described above with reference to movable plate 608, FIG. 6B. Moveable dielectric plate 916 (e.g., an alumina plate) is disposed along a direction of propagation of the waveguide 906. In some embodiment, moveable dielectric plate passes over one or more of the plurality of irises (e.g., passes over two or more of the plurality of irises). In some embodiments, the moveable dielectric plate 916 passes over each of the plurality of irises.

Tunable iris filter 900 includes an input port 912 and an exit port 914. In some embodiments, the waveguide 906 is bent (e.g., with a waveguide bend) upon entering the input port 912 (e.g., so that the direction of propagation of the input port 912 is perpendicular to the direction of propagation along a portion of the waveguide 906 that includes the irises). In some embodiments, the waveguide 906 is bent (e.g., with a waveguide bend) before entering the exit port 914 (e.g., so that the direction of propagation of the exit port 914 is perpendicular to the direction of propagation along a portion of the waveguide 906 that includes the irises).

Tunable iris filter 900 includes a drive assembly 918 for rotating the movable dielectric plate 916. In some embodiments, the drive assembly 918 rotates the moveable dielectric plate 916 about a long axis of the moveable dielectric plate 916 (e.g., along an axis that is parallel to the direction of propagation of the waveguide 906). To that end, the moveable dielectric plate 916 is coupled to the drive assembly 918 using rod 920-a. Optionally, a rod 920-b is coupled with movable dielectric plate 916 and disposed within a hole 917 that passes at least partially through waveguide 906 and stabilizes the movable dielectric plate 916. Rod 920-a passes through a hole 922 in the waveguide 906. The rod 920-a is coupled with a stepper motor 924 externally to the waveguide 906 and coupled with an end of the moveable dielectric plate 916 inside the waveguide (e.g., using a mechanical coupling 923). In some embodiments, the movable dielectric plate 916 is coupled with the stepper motor 924 without a transmission (e.g., without the need for gears, since movable dielectric plate 916 can rotate with the stepper motor 924). The rotation of the movable dielectric plate 916 within waveguide 706 changes the center frequency of the band-pass filter 900 (e.g., without substantially modifying the bandwidth of the band-pass filter 900).

The description of the present application has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

The terminology used in the description of the embodiments herein is for the purpose of describing particular embodiments only and is not intended to limit the scope of claims. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will also be understood that, although the terms first, second, etc. may be used herein to describe various elements, these elements should not be limited by these terms. These terms are only used to distinguish one element from another. For example, a first port could be termed a second port, and, similarly, a second port could be termed a first port, without departing from the scope of the embodiments. The first port and the second port are both ports, but they are not the same port.

Many modifications and alternative embodiments of the embodiments described herein will come to mind to one skilled in the art having the benefit of the teachings presented in the foregoing descriptions and the associated drawings. Therefore, it is to be understood that the scope of claims are not to be limited to the specific examples of the embodiments disclosed and that modifications and other embodiments are intended to be included within the scope of the appended claims. Although specific terms are employed herein, they are used in a generic and descriptive sense only and not for purposes of limitation.

The embodiments were chosen and described in order to best explain the underlying principles and their practical applications, to thereby enable others skilled in the art to best utilize the underlying principles and various embodiments with various modifications as are suited to the particular use contemplated.

What is claimed is:

1. An antenna coupling unit (ACU), comprising:
a plurality of ports including a transmitter port, a receiver port, and an antenna port;
a circulator that isolates the transmitter port from the receiver port;
a first waveguide that couples the transmitter port with a first port of the circulator, wherein:
the transmitter port receives an outgoing signal from first external circuitry; and
the first waveguide includes a first filter that filters the outgoing signal before routing the outgoing signal to the antenna port;
a second waveguide that couples a second port of the circulator with the receiver port, wherein:
the second waveguide includes a second filter that filters an incoming signal received through the antenna port before routing the incoming signal to the receiver port;
the receiver port provides the filtered incoming signal to second external circuitry;
a third waveguide that couples the antenna port with a third port of the circulator;
wherein at least one of the first filter and the second filter is a tunable filter.

2. The antenna coupling unit of claim 1, wherein the tunable filter is a tunable iris filter.

3. The antenna coupling unit of claim 2, wherein the tunable iris filter comprises:
a first element;
a second element that mates with the first element to form a waveguide, the waveguide comprising a plurality of irises having band-pass characteristics;
a moveable dielectric plate disposed between the first element and the second element along a direction of propagation of the waveguide; and
a drive assembly that moves the moveable dielectric plate relative to the plurality of irises.

4. The antenna coupling unit of claim 3, wherein the drive assembly varies a distance between the moveable dielectric plate and the plurality of irises.

5. The antenna coupling unit of claim 4, wherein:
the moveable dielectric plate has a hole; and
the drive assembly comprises:
external to the waveguide:
a lifter plate having a first hole and a second hole;
a shaft coupled with the lifter plate through the first hole in the lifter plate, the shaft having a threaded end distal to the first hole in the lifter plate;
a mechanical coupling having a threaded bore that mates with the threaded end of the shaft;
a stepper motor that turns the mechanical coupling;
a rod, passing through a hole in the waveguide, coupled with the lifter plate through the second hole in the lifter plate and coupled with the moveable dielectric plate through the hole in the moveable dielectric plate.

6. The antenna coupling unit of claim 3, wherein the drive assembly rotates the moveable dielectric plate about a long axis of the moveable dielectric plate.

7. The antenna coupling unit of claim 6, wherein the drive assembly comprises:
a stepper motor external to the waveguide; and
a rod passing through a hole in the waveguide, the rod coupled with the stepper motor externally to the waveguide and coupled with an end of the moveable dielectric plate inside the waveguide.

8. The antenna coupling unit of claim 3, wherein the movable dielectric plate comprises an alumina dielectric.

9. A tunable iris filter, comprising:
a first element;
a second element that mates with the first element to form a waveguide, the waveguide comprising a plurality of irises having band-pass characteristics;
a moveable dielectric plate disposed between the first element and the second element along a direction of propagation of the waveguide; and
a drive assembly that moves the moveable dielectric plate relative to the plurality of irises.

10. The tunable iris filter of claim 9, wherein the drive assembly varies a distance between the moveable dielectric plate and a top of the waveguide.

11. The tunable iris filter of claim 10, wherein:
the moveable dielectric plate has a hole; and
the drive assembly comprises:
external to the waveguide:
a lifter plate having a first hole and a second hole;
a shaft coupled with the lifter plate through the first hole in the lifter plate, the shaft having a threaded end distal to the first hole in the lifter plate;
a mechanical coupling having a threaded bore that mates with the threaded end of the shaft;
a stepper motor that turns the mechanical coupling;
a rod, passing through a hole in the waveguide, coupled with the lifter plate through the second hole in the lifter plate and coupled with the moveable dielectric plate through the hole in the moveable dielectric plate.

12. The tunable iris filter of claim 9, wherein the drive assembly rotates the moveable dielectric plate about a long axis of the moveable dielectric plate.

13. The tunable iris filter of claim 12, wherein the drive assembly comprises:
a stepper motor external to the waveguide; and
a rod passing through a hole in the waveguide, the rod coupled with the stepper motor externally to the waveguide and coupled with an end of the moveable dielectric plate inside the waveguide.

14. The tunable iris filter of claim 9, wherein the movable dielectric plate comprises an alumina dielectric.

15. A tunable septum filter, comprising:
a first element;
a second element that mates with the first element to form a waveguide;
an insert plate disposed between the first element and the second element along a direction of propagation of the waveguide; and
a movable dielectric plate disposed parallel to the insert plate;
a drive assembly that varies a distance between the movable dielectric plate and the insert plate to vary a center frequency of the tunable E-plane septum filter.

16. The tunable septum filter of claim 15, wherein the movable dielectric plate comprises an alumina dielectric.

17. The tunable septum filter of claim 15, wherein the insert plate comprises a flat sheet having a plurality of resonant cavities comprising portions removed from the flat sheet.

18. The tunable septum filter of claim 17, wherein the flat sheet comprises a flat metal sheet.

19. The tunable septum filter of claim 15, wherein:
the moveable dielectric plate has a hole; and
the drive assembly comprises:
external to the waveguide:
a lifter plate having a first hole and a second hole;
a shaft coupled with the lifter plate through the first hole in the lifter plate, the shaft having a threaded end distal to the first hole in the lifter plate;
a mechanical coupling having a threaded bore that mates with the threaded end of the shaft;
a stepper motor that turns the mechanical coupling;
a rod, passing through a hole in the waveguide, coupled with the lifter plate through the second hole in the lifter plate and coupled with the moveable dielectric plate through the hole in the moveable dielectric plate.
